(19) United States
(12) Patent Application Publication
(10) Pub. No.: US 2009/0012839 A1
(43) Pub. Date: Jan. 8, 2009

(54) Determining Brand Affiliations

(75) Inventors: Iwao Fusillo, Merrick, NY (US); Prashant Kalia, Fair Lawn, NJ (US); Suby P. Philip, Queens Village, NY (US); Danny M. Yelle, Stamford, CT (US)

Correspondence Address: STERNE, KESSLER, GOLDSTEIN & FOX, P.L.L.C., 1100 NEW YORK AVENUE, N.W., WASHINGTON, DC, 20005-3934, US

(73) Assignee: American Express Travel Related Services Company, Inc., New York, NY (US)

(21) Appl. No.: 11/772,947

(22) Filed: Jul. 3, 2007

(51) Int. Cl. G06F 17/30

(52) U.S. Cl. 705/10

(57) ABSTRACT

To determine brand affiliation, a consumer criterion may be identified. A filtered group of one or more consumers may be created in which each consumer in the filtered group is subject to the consumer criterion. A percentage of consumers in the filtered group of consumers having at least one transaction with a brand of interest may then be determined. A percentage of consumers in a control group of consumers having at least one transaction with the brand of interest may also be determined. A ratio comparing the percentage of consumers in the filtered group to the percentage of consumers in the control group may then be calculated. Based on the calculated ratio, the brand affiliation between the consumer criterion and the brand of interest is determined. This affiliation can be leveraged to target marketing materials for one of the brands to consumers of the second brand.

### BACKGROUND

1. Field of the Invention

The present invention relates to consumer marketing, specifically to selecting consumers for targeted marketing.

2. Background Art

To encourage spending, merchants often target potential customers with advertisements and/or other marketing materials. A transactional card company has an interest in encouraging its cardmembers to use an affiliated transactional card at merchants within a transactional card company network, such that the transactional card company additionally targets potential customers with marketing materials accordingly. As a number of potential customers increases, and as a number of marketing opportunities and merchants also increases, it is desirable to focus the targeted materials on those customers perceived to be most willing to respond to offers contained in the targeted materials.

Therefore, what is needed is a system and method for identifying customers most likely to respond to marketing materials for a given merchant or merchant type.

### BRIEF SUMMARY OF THE INVENTION

If an affiliation exists between two brands, then a consumer who makes a purchase at one of the brands is more likely than an average consumer to make a purchase at the other brand. This affiliation can be leveraged to target marketing materials for one of the brands to consumers of the second brand.

In one embodiment, to determine brand affiliation, a consumer criterion is identified. The consumer criterion may be, for example and without limitation, demographic information of the consumer, a type of transactional card used by the consumer, spend data of the consumer, a transaction of the consumer associated with a given brand, a spend level of the consumer associated with the given brand, or share of wallet of the consumer for the given brand. A filtered group of consumers is created, in which each consumer in the filtered group of consumers is subject to the consumer criterion. A percentage of consumers in the filtered group of consumers having at least one transaction with a brand of interest is determined. If the consumer criterion is spend with a first brand, then the brand of interest is a second brand that is different from the first brand.

In one example of this embodiment, a percentage of consumers in a control group of consumers having at least one transaction with the brand of interest is also determined. A ratio comparing the percentage of consumers in the filtered group having at least one transaction with the brand of interest to the percentage of the consumers in the control group having at least one transaction with the brand of interest is calculated. Based on the calculated ratio, the brand affiliation between the consumer criterion and the brand of interest is determined.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is a flowchart of an exemplary method for determining brand affiliation between two brands.

FIG. 2 is an exemplary chart illustrating brand usage by a filtered group.

FIG. 3 is an exemplary chart illustrating brand usage by a control group.

FIG. 4 is a flowchart of an exemplary method for ranking brands and targeting consumers.

FIG. 5 is an exemplary flowchart illustrating a ranking of secondary brands.

FIG. 6 is a flowchart of an exemplary method for determining an affiliation between a consumer criterion and a brand of interest.

FIG. 7 is a flowchart of an exemplary method for ranking brands and targeting consumers.

FIG. 8 is a flowchart of an exemplary method for determining brand affiliation, while incorporating a share of wallet of consumers.

FIG. 9 is a block diagram of an exemplary computer system useful for implementing one or more embodiments of the present invention.

The present invention will be described with reference to the accompanying drawings. The drawing in which an element first appears is typically indicated by the leftmost digit(s) in the corresponding reference number.

### DETAILED DESCRIPTION OF THE INVENTION

### I. Overview

While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

The terms “user,” “end user,” “consumer,” “customer,” “participant,” and/or the plural form of these terms are used interchangeably throughout herein to refer to those persons or entities capable of accessing, using, being affected by and/or benefiting from the tool that the present invention provides for determining brand affiliations.

Furthermore, the terms “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

A “transaction account” as used herein refers to an account associated with an open account or a closed account system (as described below). The transaction account may exist in a physical or non-physical embodiment. For example, a transaction account may be distributed in non-physical embodiments such as an account number, frequent-flyer account, telephone calling account or the like. Furthermore, a physical embodiment of a transaction account may be distributed as a financial instrument.

A financial transaction instrument may be traditional plastic transaction cards, titanium-containing, or other metal-containing, transaction cards, clear and/or translucent transaction cards, foldable or otherwise unconventionally-sized transaction cards, radio-frequency enabled transaction cards, or other types of transaction cards, such as credit, charge, debit, pre-paid or stored-value cards, or any other like financial transaction instrument.

Persons skilled in the relevant arts will understand the breadth of the terms used herein and that the exemplary descriptions provided are not intended to be limiting of the generally understood meanings attributed to the foregoing terms.

It is noted that references in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of one skilled in the art to effect such feature, structure, or characteristic in connection with other embodiments whether or not explicitly described.

### II. Determining Brand Affiliations

“Brand loyalists” are those customers who spend more than their peers at a particular merchant or brand. It is possible to identify a group of the brand loyalists for one brand, and determine the level of affiliation the same group has for other brands. Affiliation determination of those loyal to a first brand relative to other brands provides information to, for example, advertisers, allowing them to target other brand items to the customers that are loyal to the first brand.

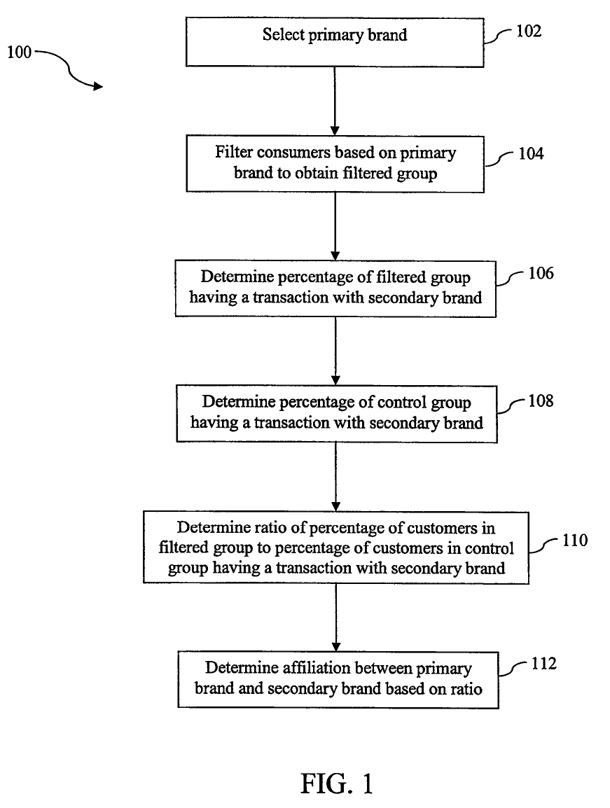

FIG. 1 is a flowchart of an exemplary method 100 for determining affiliation between two brands. In step 102, a primary brand of interest is selected. The primary brand may be, for example and without limitation, an online web store, a brick-and-mortar establishment, a manufacturer, a service provider, or a specific product. Once the primary brand has been selected, method 100 proceeds to step 104.

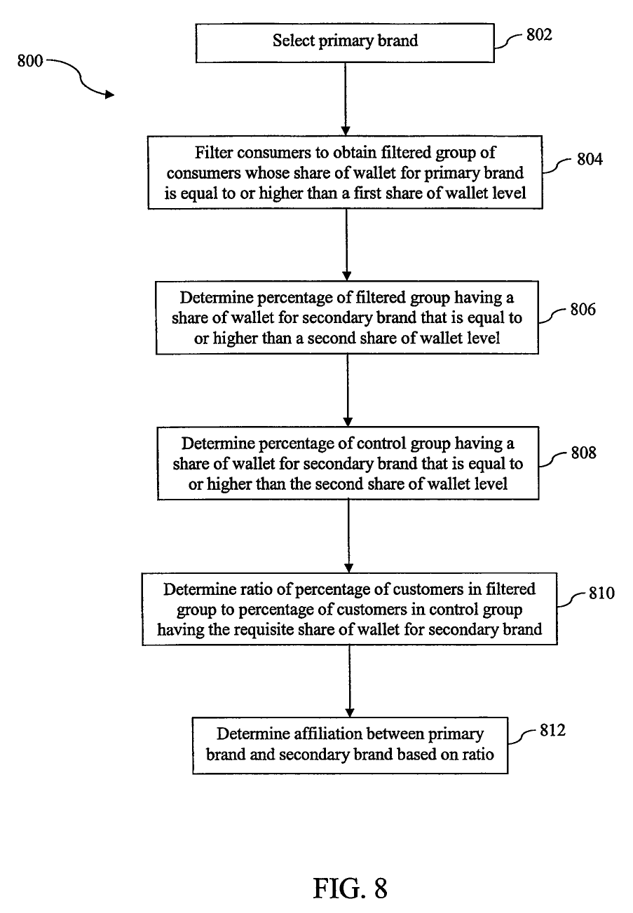

In step 104, a filtered group of consumers (e.g., brand loyalists) is created. The filtered group of consumers may be selected from, for example, all cardholders of a transactional account company such as American Express Co., of New York, N.Y. Each consumer in the filtered group of consumers may have had, for example, a transaction with the primary brand in a given previous time period. The time period may be, for example and without limitation, three months. In the embodiment described with respect to FIG. 1, each consumer in the filtered group of consumers has had at least one transaction with the primary brand in the given time period. In another embodiment, each consumer in the filtered group of consumers has had a specified number of transactions with the primary brand greater than one in the given time period. In yet another embodiment, each consumer in the filtered group of consumers has had a given level of spend and/or spend ratio with the primary brand. In still another embodiment, as will be described in further detail with respect to FIG. 8, a share of wallet of each consumer in the filtered group of consumers for the primary brand meets a specified share of wallet. One of skill in the art will recognize that other criteria for transactions with the primary brand may be applied to determine the filtered group of consumers, with the examples provided with respect to method 100 adjusted accordingly.

In the example of FIG. 1, each consumer in the filtered group of consumers has at least one transaction with the primary brand in their transaction history. That is, 100% of consumers in the filtered group of consumers have at least one transaction with the primary brand. Once the filtered group has been created, method 100 proceeds to step 106.

In step 106, a percentage of consumers in the filtered group of consumers who have had at least one transaction with a secondary brand are determined. For example, if the filtered group of consumers includes all cardmembers of a transactional account company who have made a purchase at a primary brand, the records of the primary brand shoppers can be analyzed to determine how many of the same cardmembers made a purchase at a secondary brand. Additionally or alternatively, the percentage of consumers may include those consumers in the filtered group who have had a given level of transactions, spend, spend ratio, and/or, as will be further described with respect to FIG. 8, share of wallet with the secondary brand. The secondary brand may be, for example and without limitation, an online web store, a brick-and-mortar establishment, a manufacturer, a service provider, or a specific product. The type of the secondary brand may be the same as or different from the type of the primary brand. Step 106 may be performed for a single secondary brand, or it may be performed for a plurality of secondary brands. In one example embodiment, step 106 is performed using the top 500 brands of a transactional account company as the secondary brands. In another example embodiment, step 106 is performed using the top 1000 brands of the transactional account company as the secondary brands. One of skill in the art will recognize that step 106 may be performed for any number of secondary brands without departing from the spirit and scope of the present invention.

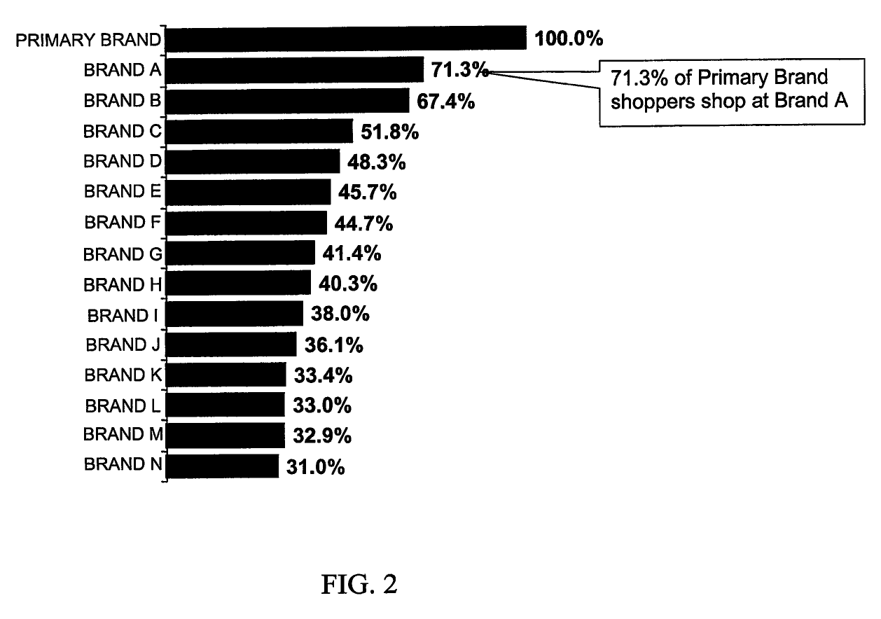

FIG. 2 is an exemplary chart illustrating the results of step 106 in an example secondary brand inquiry. In FIG. 2, the primary brand is illustrated as having 100% of the consumers in the filtered group having a transaction history with the primary brand. The percentage of primary brand consumers who transacted with (e.g., made purchases associated with) various secondary brands A through N is also illustrated. In the example of FIG. 2, 71.3% of primary brand consumers also had a transaction associated with Brand A; 67.4% of primary brand consumers also had a transaction with Brand B, and so on as illustrated for each secondary brand.

Returning to FIG. 1, in step 108, the percentage of consumers in a control group of consumers having at least one transaction with a secondary brand is determined. Additionally or alternatively, the percentage of consumers may include those consumers in the control group who have had a given level of transactions, spend, spend ratio, and/or, as will be further described with respect to FIG. 8, share of wallet with the secondary brand. As with step 106, step 108 may be performed for a single secondary brand, or it may be performed for a plurality of secondary brands. In one example, the secondary brand(s) analyzed in step 108 are the same as the secondary brand(s) analyzed in step 106. In an embodiment, the control group represents the average consumer. The control group may include both consumers who have made a purchase with the primary brand and consumers who have not made a purchase with the primary brand. Alternatively, the control group may include only those consumers who have not made a purchase with the primary brand. In one embodiment, the control group includes all cardmembers of a transactional account company. In another embodiment, the control group includes a subset of cardmembers of the transactional account company.

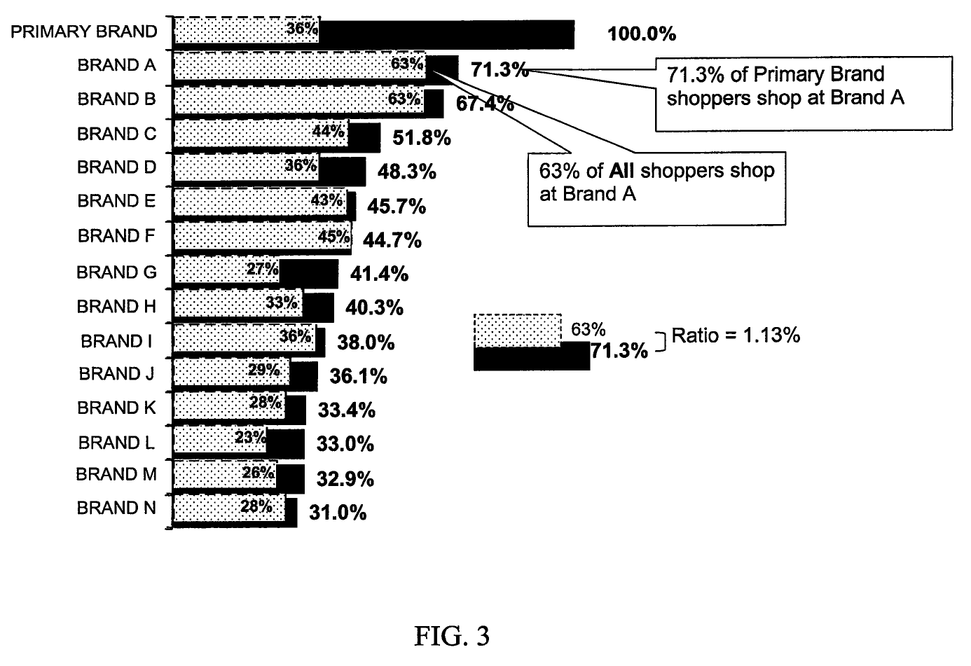

FIG. 3 is an exemplary chart illustrating the results of step 108 in an example inquiry. The results of step 108 are illustrated on top of the results of step 106 for comparison (e.g., the dark bars represent the results of step 106, while the lighter bars represent the results of step 108). In this example, the control group includes both consumers who made purchases associated with the primary brand and consumers who did not make purchases associated with the primary brand. The example percentage of consumers in the control group who made a purchase associated with the primary brand is 36%, the percentage of consumers in the control group who made a purchase associated with Brand A is 63%, the percentage of consumers in the control group who made a purchase associated with Brand B is 63%, etc.

Returning to FIG. 1, in step 110, the ratio of the percentage of consumers in the filtered group of consumers having at least one transaction with the second brand to the percentage of consumers in the control group of consumers having at least one transaction with the second brand is calculated. Specifically:

$$Ratio = \frac{\% FilteredGroup}{\% ControlGroup} . \qquad ( Eq . 1 )$$

In the example of FIG. 3, 71.3% of primary brand consumers (i.e., the filtered group) made a purchase associated with Brand A, while only 63% of the control group made a purchase associated with Brand A. This provides a ratio of approximately 1.13. Once the ratio has been calculated, method 100 proceeds to step 112.

In step 112, the brand affiliation between the primary brand and the secondary brand is determined based on the calculated ratio. In the above example, a ratio greater than 1 means that consumers of the primary brand are more likely to make a purchase from the secondary brand than the average consumer. When this occurs, an affiliation is determined to exist between the brands. One of skill in the art will recognize that there are other similar ways of determining a brand affiliation without departing from the spirit and scope of the present invention. For example, the ratio calculation may be inverted, such that the percentage of consumers in the control group having a transaction associated with the secondary brand is divided by the percentage of consumers in the filtered group having a transaction with the secondary brand, and affiliation determined when the ratio is less than 1. In another example, the calculation may be based on an actual number of consumers in each of the filtered group and the control group, rather than a percentage.

As illustrated in FIG. 3, the primary brand is determined to be affiliated with Brand A, because the ratio of the percentage of primary brand consumers who made a purchase associated with Brand A compared to the percentage of the control group who made a purchase associated with Brand A is greater than 1. When there are a plurality of secondary brands, the brand affiliation between the primary brand and each secondary brand may also be made. For example, 48.3% of consumers in the filtered group of primary brand consumers also made a purchase associated with Brand D, while only 36% of consumers in the control group made a purchase associated with Brand D, resulting in a ratio of approximately 1.34. Because the ratio is greater than 1, the primary brand is determined in step 112 to be affiliated with Brand D. In another example, 44.7% of consumers in the filtered group of primary brand consumers also made a purchase associated Brand F, while 45% of consumers in the control group made a purchase associated with Brand F, resulting in a ratio of approximately 0.99. Because the ratio is less than 1, the primary brand is determined in step 112 to be not affiliated with Brand F.

Method 100 may be repeated for a different primary brand. Where the previous primary brand was compared to a plurality of secondary brands, the new primary brand may be, for example, one of the previous secondary brands. In an example where a transactional account company is interested in brand affiliations between its top 500 merchants, method 100 may be performed using each of the top 500 merchants as a primary brand being compared to the other 499 merchants as secondary brands. In this example, once method 100 has been performed enough times for each merchant to be a primary brand, a matrix of brand affiliations can be compiled.

The matrix of brand affiliations can be used in many ways. In one embodiment, the matrix is used to support an Internet search engine. For example, if a user requests information regarding a first brand from the search engine, information about an affiliated secondary brand may be returned in response using the matrix as a look-up. In another example, if a user requests information regarding the first brand from the search engine, the user may be supplied with an advertisement for the affiliated secondary brand in return.

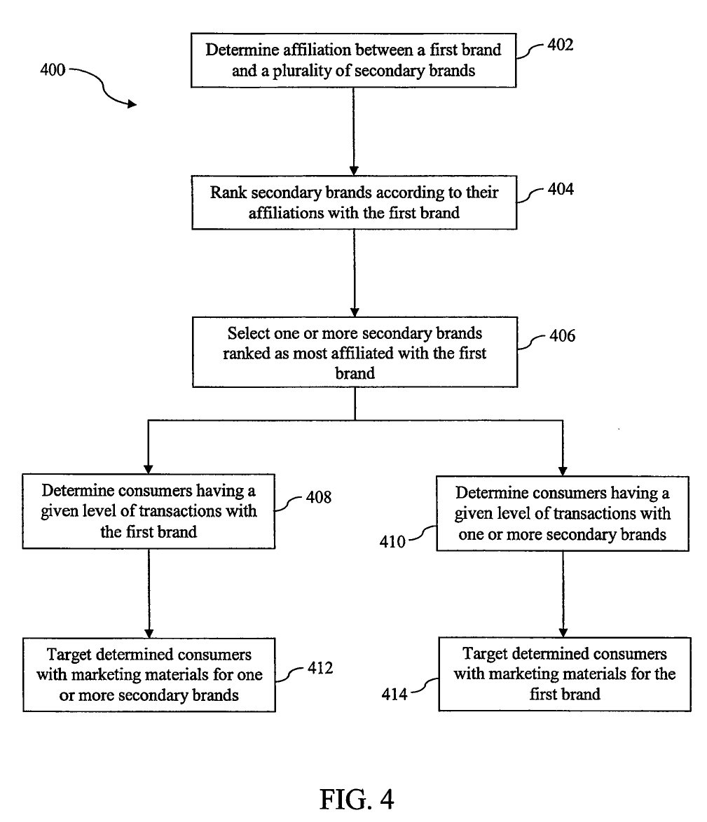

In the example where a plurality of secondary brands are used, once the affiliations between a primary brand and a plurality of secondary brands have been determined, the affiliations can be ranked. FIG. 4 is a flowchart of an example method 400 for ranking secondary brands and targeting consumers. In step 402, the affiliation between the primary brand and the plurality of secondary brands is determined using, for example, method 100. Method 400 then proceeds to step 404.

In step 404, the secondary brands are ranked according to their affiliations with the primary brand. The ranking order may be determined based on, for example, the ratio comparing the percentage of consumers in the filtered group having a transaction associated with a secondary brand to the percentage of consumers in the control group having a transaction associated with the same secondary brand, as calculated in step 110 of method 100. The ranking may indicate, for example, the levels of strength of affiliation between the primary brand and the secondary brands, such as the secondary brands most affiliated with the primary brand and the secondary brands least affiliated with the primary brand.

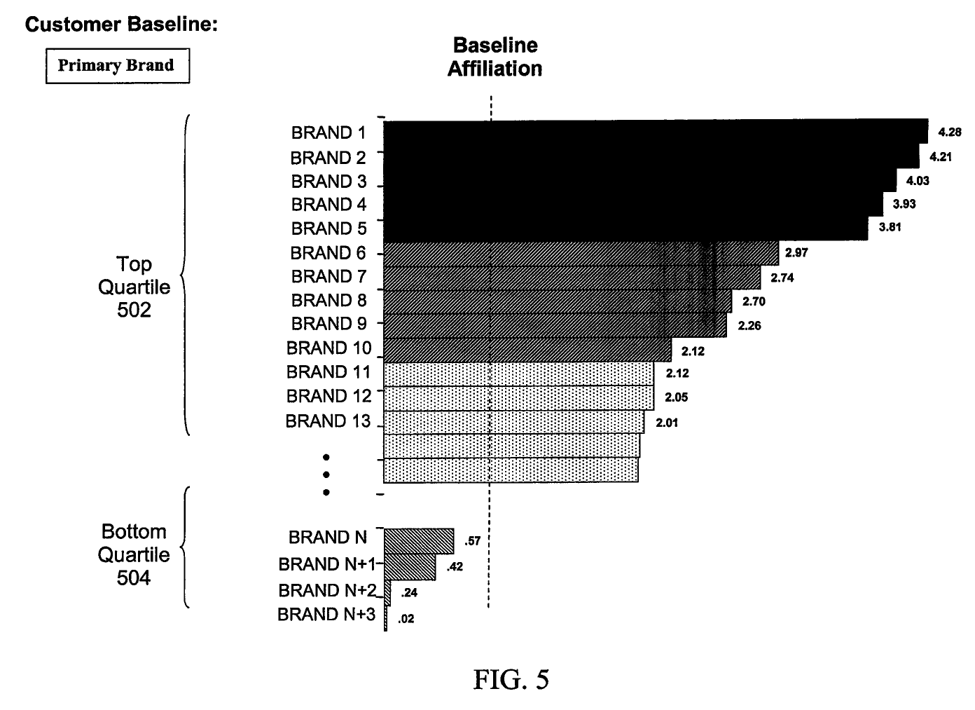

FIG. 5 is an exemplary chart illustrating a ranking of secondary brands for a given primary brand. In this example, the top quartile 502 of secondary brands having an affiliation with the primary brand have been identified. Similarly, the bottom quartile 504 of secondary brands having an affiliation with the primary brand have also been identified.

Once the secondary brands have been ranked, the rankings may be used for various purposes. In an embodiment, the rankings are used to target advertisements and/or other marketing materials to potential customers of one or both of the primary brand and a secondary brand.

Returning to method 400 in FIG. 4, in step 406, one or more secondary brands ranked as most affiliated with the primary brand are selected. If the secondary brands are selected for marketing purposes, the number of secondary brands selected may depend on the budget available for a marketing campaign so that materials are focused on those consumers most likely to respond to the materials. For example, top quartile 502 in FIG. 5 may be selected, since positive affiliations between the primary brand and secondary brands in top quartile 502 have been identified. Method 400 then proceeds to one (or both) of step 408 or 410.

In step 408, one or more consumers having a given level of transactions with the primary brand are selected. In one embodiment, the consumers are selected from all cardmembers of a transactional account company. In another embodiment, the consumers are selected from the filtered group of consumers used in method 100. A transaction history of a selected consumer may need to include, for example, at least one transaction associated with the primary brand. In another example, the transaction history of a selected consumer may need to include a higher number of transactions associated with the primary brand. In yet another example, a share of wallet of the selected consumer associated with the primary brand may need to meet a given level. Once the consumers have been selected in step 408, method 400 proceeds to step 412.

In step 412, the consumers selected in step 408 are targeted with marketing materials for one or more of the secondary brands selected in step 406. The marketing materials may include, for example and without limitation, direct mail, an electronic message, a telephone message, or a multi-media message.

Additionally, or alternatively, in step 410, one or more consumers having a given level of transactions with at least one of the most affiliated secondary brands are selected. The consumers may be selected, for example, from all cardmembers of a transactional account company. A transaction history of a selected consumer may need to include, for example, at least one transaction associated with a secondary brand. In another example, the transaction history of a selected consumer may need to include a higher number of transactions associated with the secondary brand. In yet another example, a share of wallet of the selected consumer associated with the secondary brand may need to meet a given level. Once the consumers have been selected in step 410, method 400 proceeds to step 414.

In step 414, the consumers selected in step 410 are targeted with marketing materials for the primary brand, which materials may be similar to those described above in relation to step 412.

FIGS. 1 through 5 have been described herein as determining and utilizing the brand affiliation between a primary brand and one or more secondary brands. However, methods similar to method 100 and method 400 can also be performed to determine and utilize a brand affiliation between a non-brand consumer criterion and one or more brands.

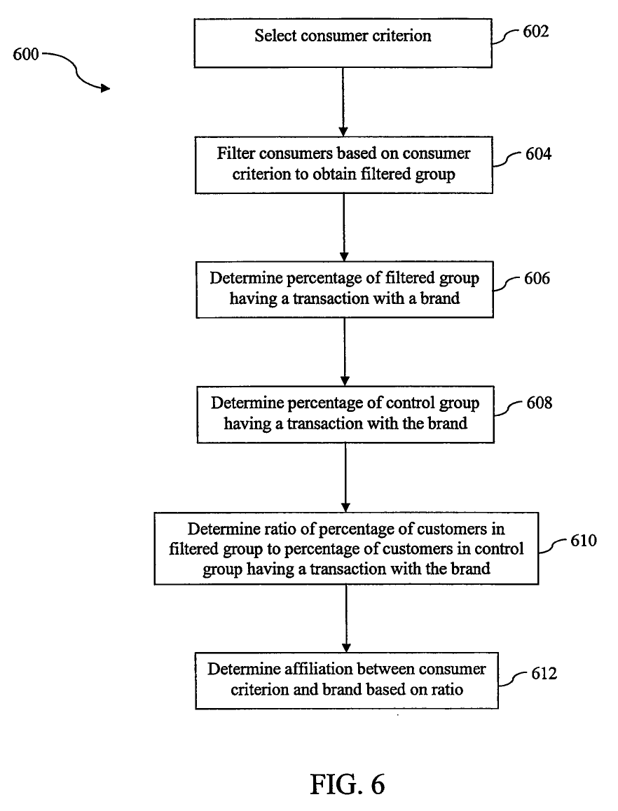

FIG. 6 illustrates a method 600 for determining the affiliation between a consumer criterion and a brand of interest. The consumer criterion may be, for example and without limitation, whether the consumer is a member of a rewards program of a transactional account company, whether the consumer uses a transactional card having a different status level than other transactional cards of a transactional account company (e.g., an elite status card, a basic status card, etc.), or a given demographic (e.g., age, gender, marital status, etc.). The consumer criterion may also be a brand different from the brand of interest, such that method 600 performs similar steps as method 100 (FIG. 1). One of skill in the art will recognize that the consumer criterion may also be any other criterion that classifies a group of consumers, and that the consumer criterion may actually be a plurality of consumer criteria. The specific consumer criterion of interest is selected in step 602 of method 600.

In step 604, a filtered group of consumers is created. Each consumer in the filtered group of consumers is associated with the consumer criterion. In the example where the consumer criterion is ownership of an elite status transactional card of a transactional account company (such as the American Express Platinum Card®), each consumer in the filtered group of consumers has been issued an elite status transactional card. The filtered group of consumers may be selected from, for example, all cardmembers of the transactional account company.

Step 606 is similar to step 106 of method 100 (FIG. 1). In step 606, a percentage of consumers in the filtered group of consumers who have had at least one transaction with a brand of interest are determined. For example, if the filtered group of consumers includes consumers having an elite status credit card, the records of the elite status credit card holders are analyzed to determine how many of the same consumers made a purchase at the brand of interest. The brand of interest may be, for example and without limitation, an online web store, a brick-and-mortar establishment, a manufacturer, a service provider, or a specific product. Step 606 may be performed for a single brand of interest, or it may be performed for a plurality of brands of interest. In one example, step 606 is performed using the top 500 brands of a transactional account company as the brands of interest. In another example, step 606 is performed using the top 1000 brands of the transactional account company as the brands of interest. One of skill in the art will recognize that step 606 may be performed for any number of brands without departing from the spirit and scope of the present invention.

In step 608, the percentage of consumers in a control group of consumers who have had at least one transaction with the brand of interest is determined. Step 608 operates in a manner similar to step 108 of method 100 (FIG. 1), and is therefore not further described here.

In step 610, a ratio of the percentage of consumers in the filtered group of consumers having at least one transaction with the brand of interest to the percentage of consumers in the control group of consumers having at least one transaction with the brand of interest is calculated using, for example, Eq. 1 (above). Once the ratio has been calculated, method 600 proceeds to step 612.

In step 612, the brand affiliation between the consumer criterion and the brand of interest is determined based on the calculated ratio. As discussed in the above example, a ratio greater than 1 means that consumers associated with the consumer criterion are more likely to make a purchase associated with the brand of interest than the average consumer. When this occurs, an affiliation is identified between the consumer criterion and the brand of interest. One of skill in the art will recognize that there are other similar ways of calculating the brand affiliation without departing from the spirit and scope of the present invention. For example, the ratio calculation may be inverted, such that the percentage of consumers in the control group having a transaction associated with the brand of interest is divided by the percentage of consumers in the filtered group having a transaction with the brand of interest, and affiliation is determined when the ratio is less than 1. In another example, the calculation may be based on an actual number of consumers in each of the filtered group and the control group having a transaction associated with the brand of interest, rather than a percentage.

The determination of affiliations between brands of interest and a consumer criterion can indicate various spend characteristics about consumers associated with the consumer criterion. For example, where the consumer criterion is ownership of an elite status transactional card, it can be determined that consumers associated with the consumer criterion are more likely to shop at luxury merchants in travel and retail. In another example where the consumer criterion is a basic status transactional card, it can be determined that consumers associated with the consumer criterion are more likely to shop at online discount stores (particularly electronics discount stores) and discount and/or inexpensive retail stores. In an example where the consumer criterion is that the consumer is a young, single male, it can be determined that consumers associated with the consumer criterion are more likely to make entertainment- and travel-related purchases. In an example where the consumer criterion is that the consumer is a young, single female, it can be determine that consumers associated with the consumer criterion are more likely to have transaction records dominated by clothing retailers. In an example where the consumer criterion is that the consumer is a senior citizen, it can be determined that consumers associated with the consumer criterion are more likely to make cruise line purchases.

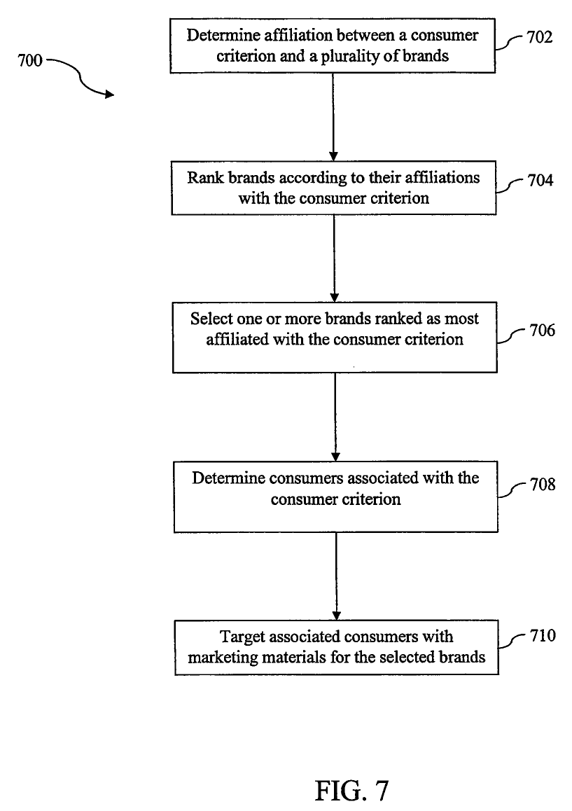

Once the affiliations between a consumer criterion and a plurality of brands of interest are determined, the brands of interest may be ranked in order to target consumers with, for example, marketing materials. FIG. 7 is a flowchart of an exemplary method 700 for ranking brands of interest and targeting consumers. In step 702, the affiliations between the consumer criterion and a plurality of brands of interest are determined using, for example, method 600. Method 700 then proceeds to step 704.

In step 704, the brands of interest are ranked according to their affiliations with the consumer criterion. The ranking order may be determined based on, for example, the ratio comparing the percentage of consumers in the filtered group having a transaction associated with the brand of interest to the percentage of consumers in the control group having a transaction associated with the same brand of interest, as calculated in step 610 of method 600. The ranking may indicate, for example, the brands of interest most affiliated with the consumer criterion and the brands of interest least affiliated with the consumer criterion.

Once the brands of interest have been ranked, the rankings may be used for various purposes. In an embodiment, the rankings are used to target advertisements and/or other marketing materials to potential customers of one or more brands of interest. In step 706, one or more brands of interest ranked as most affiliated with the consumer criterion are selected. As with step 406 of method 400 (FIG. 4), if the brands of interest are selected for marketing purposes, the number of brands of interest selected may depend on the budget available for a marketing campaign so that materials are focused on those consumers most likely to respond to the materials.

In step 708, consumers associated with the consumer criterion are selected. In one embodiment, the consumers are selected from all cardmembers of a transactional account company. In another embodiment, the consumers are selected from the filtered group of consumers used in method 600. Once the consumers have been selected in step 708, method 700 proceeds to step 710.

In step 710, the consumers selected in step 708 are targeted with marketing materials for one or more of the brands of interest selected in step 706.

In method 100 of FIG. 1, the brand affiliation is determined based on a filtered group of consumers having at least one transaction with a primary brand and/or at least one transaction with a secondary brand. In method 600 of FIG. 2, the brand affiliation is determined based on a filtered group of consumers having at least one transaction with a brand of interest. However, it is possible to make the requirement for the filtered group of consumers more limited. For example, brand affiliation may be determined based on a filtered group of consumers whose share of wallet associated with a primary brand, a secondary brand, and/or a brand of interest meets a given level.

FIG. 8 is a flowchart of an exemplary method 800 for determining brand affiliations while incorporating the share of wallet of the consumers. In step 802, a primary brand is selected. Step 802 operates in a manner similar to that of step 102 of method 100 (FIG. 1), and is therefore not further described herein.

In step 804, a filtered group of consumers is created. The filtered group of consumers may be selected from, for example, all cardholders of a transactional account company. Each consumer in the filtered group of consumers is selected based on the estimated share of wallet of the respective consumer for the primary brand. If a size of wallet of the consumer is represented by the consumer's total aggregate spending, the share of wallet represents how the customer divides that total spending. In the context of brands, the share of wallet of a consumer for a given brand represents the amount or percentage of the size of wallet the consumer spends on purchases associated with the given brand. The estimated share of wallet of a consumer for a given brand may be calculated, for example, as described in U.S. Pat. Pub. No. 2006/0242039, published Oct. 26, 2006, titled “Method and Apparatus for Estimating the Spend Capacity of Consumers,” which is hereby incorporated by reference in its entirety. In one embodiment, the share of wallet for the primary brand for each consumer in the filtered group of consumers meets a first share of wallet level or amount.

In step 806, a percentage of consumers in the filtered group of consumers whose share of wallet for a secondary brand meets a second share of wallet level or amount is determined. Step 806 may be performed for a single secondary brand, or it may be performed for a plurality of secondary brands. One of skill in the art will recognize that step 806 may be performed for any number of brands without departing from the spirit and scope of the present invention.

In step 808, a percentage of consumers in a control group of consumers whose share of wallet for the secondary brand(s) meets the second share of wallet level or amount is determined.

In step 810, the ratio of the percentage of consumers in the filtered group of consumers having a specified share of wallet for the secondary brand to the percentage of consumers in the control group of consumers having the specified share of wallet for the secondary brand is calculated using, for example, Eq. 1 (above). Once the ratio has been calculated, method 800 proceeds to step 812.

In step 812, the brand affiliation between the primary brand and the secondary brand is determined based on the calculated ratio. Step 812 operates in a manner similar to that of step 112 of method 100 (FIG. 1), and is therefore not described in further detail here.

One of skill in the art will recognize that various modifications and combinations of the methods described in FIG. 8 above may be implemented without departing from the spirit and scope of the present invention. For example, a method may be performed to determine the brand affiliation between a consumer criterion and a brand of interest, wherein the affiliation determination takes into account consumers' shares of wallet with the brand of interest. In another example, any of steps 804, 806, or 808 may be performed by selecting consumers having a given number of transactions with a primary and/or secondary brand rather than by selecting consumers having a specified share of wallet with a primary and/or secondary brand.

### III. Example Implementations

The present invention or any part(s) or function(s) thereof may be implemented using hardware, software or a combination thereof and may be implemented in one or more computer systems or other processing systems. However, the manipulations performed by the present invention were often referred to in terms, such as adding or comparing, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices.

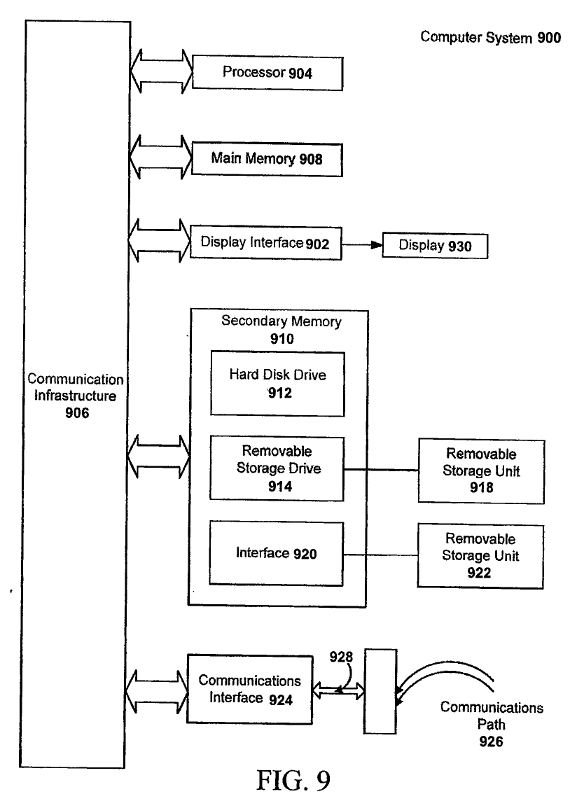

In fact, in one embodiment, the invention is directed toward one or more computer systems capable of carrying out the functionality described herein. An example of a computer system 900 is shown in FIG. 9.

The computer system 900 includes one or more processors, such as processor 904. The processor 904 is connected to a communication infrastructure 906 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 900 can include a display interface 902 that forwards graphics, text, and other data from the communication infrastructure 906 (or from a frame buffer not shown) for display on the display unit 930.

Computer system 900 also includes a main memory 908, preferably random access memory (RAM), and may also include a secondary memory 910. The secondary memory 910 may include, for example, a hard disk drive 912 and/or a removable storage drive 914, representing a floppy disk drive, a magnetic tape drive, an optical disk drive, etc. The removable storage drive 914 reads from and/or writes to a removable storage unit 918 in a well known manner. Removable storage unit 918 represents a floppy disk, magnetic tape, optical disk, etc. which is read by and written to by removable storage drive 914. As will be appreciated, the removable storage unit 918 includes a computer usable storage medium having stored therein computer software and/or data.

In alternative embodiments, secondary memory 910 may include other similar devices for allowing computer programs or other instructions to be loaded into computer system 900. Such devices may include, for example, a removable storage unit 922 and an interface 920. Examples of such may include a program cartridge and cartridge interface (such as that found in video game devices), a removable memory chip (such as an erasable programmable read only memory (EPROM), or programmable read only memory (PROM)) and associated socket, and other removable storage units 922 and interfaces 920, which allow software and data to be transferred from the removable storage unit 922 to computer system 900.

Computer system 900 may also include a communications interface 924. Communications interface 924 allows software and data to be transferred between computer system 900 and external devices. Examples of communications interface 924 may include a modem, a network interface (such as an Ethernet card), a communications port, a Personal Computer Memory Card International Association (PCMCIA) slot and card, etc. Software and data transferred via communications interface 924 are in the form of signals 928 which may be electronic, electromagnetic, optical or other signals capable of being received by communications interface 924. These signals 928 are provided to communications interface 924 via a communications path (e.g., channel) 926. This channel 926 carries signals 928 and may be implemented using wire or cable, fiber optics, a telephone line, a cellular link, a radio frequency (RF) link and other communications channels.

In this document, the terms “computer program medium” and “computer usable medium” are used to generally refer to media such as removable storage drive 914 and a hard disk installed in hard disk drive 912. These computer program products provide software to computer system 900. The invention is directed to such computer program products.

Computer programs (also referred to as computer control logic) are stored in main memory 908 and/or secondary memory 910. Computer programs may also be received via communications interface 924. Such computer programs, when executed, enable the computer system 900 to perform the features of the present invention, as discussed herein. In particular, the computer programs, when executed, enable the processor 904 to perform the features of the present invention. Accordingly, such computer programs represent controllers of the computer system 900.

In an embodiment where the invention is implemented using software, the software may be stored in a computer program product and loaded into computer system 900 using removable storage drive 914, hard drive 912 or communications interface 924. The control logic (software), when executed by the processor 904, causes the processor 904 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

### IV. Conclusion

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the figures and screen shots illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A method of determining brand affiliation, comprising:
(a) determining a consumer criterion;
(b) creating a filtered group of consumers wherein each consumer in the filtered group of consumers is subject to the consumer criterion;
(c) determining a percentage of consumers in the filtered group of consumers having at least one transaction with a brand of interest;
(d) determining a percentage of consumers in a control group of consumers having at least one transaction with the brand of interest;
(e) calculating a ratio of (i) the percentage of consumers in the filtered group of consumers having at least one transaction with the brand of interest compared to (ii) the percentage of consumers in the control group having at least one transaction with the brand of interest;
(f) determining the brand affiliation between the consumer criterion and the brand of interest based on the calculated ratio;
(g) outputting the brand affiliation; and
(h) executing a marketing campaign based on the output brand affiliation.

2. The method of claim 1, wherein:
step (c) comprises determining a percentage of consumers in the filtered group of consumers having a given level of at least one of spend, transactions, and spend ratio with the brand of interest;
step (d) comprises determining a percentage of consumers in the control group of consumers having the given level of at least one of spend, transactions, and spend ratio with the brand of interest; and
step (e) comprises calculating a ratio of (i) the percentage of consumers in the filtered group of consumers having the given level of at least one of spend, transactions, and spend ratio with the brand of interest compared to (ii) the percentage of consumers in the control group having the given level of at least one of spend, transactions, and spend ratio with the brand of interest.

3. The method of claim 2, wherein step (f) comprises determining levels of strength of affiliation between the consumer criterion and the brand of interest based on the calculated ratio between i and ii.

4. The method of claim 1, wherein the consumer criterion is a record of charge with a brand that is different from the brand of interest.

5. The method of claim 4, wherein the filtered group of consumers includes consumers of a transactional account company having the record of charge with the brand that is different from the brand of interest.

6. The method of claim 1, wherein the filtered group of consumers is a subset of the control group.

7. The method of claim 6, wherein the control group of consumers includes all consumers of a transactional account company.

8. The method of claim 1, wherein the consumer criterion is a minimum share of wallet of a consumer for a brand that is different from the brand of interest.

9. The method of claim 1, wherein step (h) comprises:
(i) receiving a search term input by a user; and
(ii) utilizing the output brand affiliation when returning search results to the user.

10. The method of claim 1, further comprising:
(i) repeating steps (b) through (f) with at least one of a different consumer criterion or a different brand of interest; and
(j) creating a matrix of affiliations between each of the consumer criteria and the brands of interest.

11. A system for determining brand affiliation, comprising:
a processor; and
a memory in communication with the processor, the memory for storing a plurality of processing instructions for directing the processor to:
determine a consumer criterion;
create a filtered group of consumers wherein each consumer in the filtered group of consumers is subject to the consumer criterion;
determine a percentage of consumers in the filtered group of consumers having at least one transaction with a brand of interest;
determine a percentage of consumers in a control group of consumers having at least one transaction with the brand of interest;
calculate a ratio of (i) the percentage of consumers in the filtered group of consumers having at least one transaction with the brand of interest compared to (ii) the percentage of consumers in the control group having at least one transaction with the brand of interest;
determine the brand affiliation between the consumer criterion and the brand of interest based on the calculated ratio;
output the brand affiliation; and
execute a marketing campaign based on the output brand affiliation.

12. The system of claim 11, wherein:
the instructions for directing the processor to determine a percentage of consumers in the filtered group of consumers comprise instructions for directing the processor to determine a percentage of consumers in the filtered group of consumers having a given level of at least one of spend, transactions, and spend ratio with the brand of interest;
the instructions for directing the processor to determine a percentage of consumers in the control group of consumers comprise instructions for directing the processor to determine a percentage of consumers in the control group of consumers having the given level of at least one of spend, transactions, and spend ratio with the brand of interest; and
the instructions for directing the processor to calculate comprise instructions for directing the processor to calculate a ratio of (i) the percentage of consumers in the filtered group of consumers having the given level of at least one of spend, transactions, and spend ratio with the brand of interest compared to (ii) the percentage of consumers in the control group having the given level of at least one of spend, transactions, and spend ratio with the brand of interest.

13. The system of claim 12, wherein the instructions for directing the processor to determine the brand affiliation comprise instructions for directing the processor to determine levels of strength of affiliation between the consumer criterion and the brand of interest based on the calculated ratio between i and ii.

14. The system of claim 11, wherein the consumer criterion is a record of charge with a brand that is different from the brand of interest.

15. The system of claim 14, wherein the filtered group of consumers includes consumers of a transactional account company having the record of charge with the brand that is different from the brand of interest.

17. The system of claim 11, further comprising instructions for directing the processor to:
determine an additional brand affiliation based on at least one of a different consumer criterion or a different brand of interest; and
create a matrix of affiliations between each of the consumer criteria and the brands of interest.

18. The system of claim 11, wherein the consumer criterion is a minimum share of wallet of a consumer for a brand that is different from the brand of interest.

19. A computer program product comprising a computer usable medium having control logic stored therein for causing a computer to determine brand affiliation, said control logic comprising:
first computer readable program code means for causing the computer to determine a consumer criterion;
second computer readable program code means for causing the computer to create a filtered group of consumers wherein each consumer in the filtered group of consumers is subject to the consumer criterion;
third computer readable program code means for causing the computer to determine a percentage of consumers in the filtered group of consumers having at least one transaction with a brand of interest;
fourth computer readable program code means for causing the computer to determine a percentage of consumers in a control group of consumers having at least one transaction with the brand of interest;
fifth computer readable program code means for causing the computer to calculate a ratio of (i) the percentage of consumers in the filtered group of consumers having at least one transaction with the brand of interest compared to (ii) the percentage of consumers in the control group having at least one transaction with the brand of interest;
sixth computer readable program code means for causing the computer to determine the brand affiliation between the consumer criterion and the brand of interest based on the calculated ratio;
seventh computer readable program code means for causing the computer to output the brand affiliation; and
eighth computer readable program code means for causing the computer to execute a marketing campaign based on the output brand affiliation.

20. The computer program product of claim 19, wherein the consumer criterion is a record of charge with a brand that is different from the brand of interest, and the filtered group of consumers includes consumers of a transactional account company having the record of charge with the brand that is different from the brand of interest.

21. The computer program product of claim 19, further comprising:
ninth computer readable program code means for causing the computer to determine a brand affiliation based on at least one of a different consumer criterion or a different brand of interest; and
tenth computer readable program code means for causing the computer to create a matrix of affiliations between each of the consumer criteria and the brands of interest.

22. The computer program product of claim 19, wherein the consumer criterion is a minimum share of wallet of a consumer for a brand that is different from the brand of interest.

23. The computer program product of claim 19, wherein:
the second computer readable program code means comprises seventh computer readable program code means for causing the computer to determine a percentage of consumers in the filtered group of consumers having a given level of at least one of spend, transactions, and spend ratio with the brand of interest;
the third computer readable program code means comprises eighth computer readable program code means for causing the computer to determine a percentage of consumers in the control group of consumers having the given level of at least one of spend, transactions, and spend ratio with the brand of interest; and
the fourth computer readable program code means comprises ninth computer readable program code means for causing the computer to calculate a ratio of (i) the percentage of consumers in the filtered group of consumers having the given level of at least one of spend, transactions, and spend ratio with the brand of interest compared to (ii) the percentage of consumers in the control group having the given level of at least one of spend, transactions, and spend ratio with the brand of interest.
